(19) United States
(12) Patent Application Publication
(10) Pub. No.: US 2026/0195317 A1
(43) Pub. Date: Jul. 9, 2026

(54) DYNAMIC DEPENDENCY MAPPING

(71) Applicant: WELLS FARGO BANK, N.A., San Francisco, CA (US)

(72) Inventors: Deepak DALLI, Hyderabad (IN); Mohan Gopal KANALA, Hyderabad (IN); Rameshchandra Bhaskar KETHARAJU, Hyderabad (IN); Sachin S. KULKARNI, Hyderabad (IN)

(21) Appl. No.: 19/009,506

(22) Filed: Jan. 3, 2025

(51) Int. Cl. G06F 16/23; G06F 18/2413

(52) U.S. Cl. CPC G06F 16/2365; G06F 18/24147

(57) ABSTRACT

An example computer system for mapping component dependencies can include one or more processors and non-transitory computer-readable storage media encoding instructions. The instructions, when executed by the one or more processors, causes the computer system to obtain incident data for a plurality of components, the incident data including times of incident occurrence at components of the plurality of components, determine potential dependencies among said components of the components of the plurality of components, based on times of incident occurrence at said components of the plurality of components, and update a database including dependency information for the plurality of components based on the determined potential dependencies.

### BACKGROUND

Dependencies among networked components can be manually mapped, for example by creation of components in a database. The manual mapping requires awareness of the dependencies and can be inaccurate based on human error or can become outdated when not maintained. Such maintenance can be difficult in large and/or rapidly changing networks where components are constantly added, changed, or removed. Additionally, while application performance management (APM) can track some dependencies, not all components are included in or interact with the APM.

### SUMMARY

This disclosure relates to dynamically generating a map of dependencies among components in a system.

In one aspect, an example computer system for mapping component dependencies includes one or more processors and non-transitory computer-readable storage media encoding instructions. The instructions, when executed by the one or more processors, causes the computer system to obtain incident data for a plurality of components, the incident data including times of incident occurrence at components of the plurality of components, determine potential dependencies among said components of the components of the plurality of components, based on times of incident occurrence at said components of the plurality of components, and update a database including dependency information for the plurality of components based on the determined potential dependencies.

In another aspect, an example method for mapping dependencies in a system includes obtaining incident data for a plurality of components, the incident data including times of incident occurrence at components of the plurality of components, determining potential dependencies among said components of the plurality of components, based on times of incident occurrence at said components of the plurality of components, and updating a database including dependency information for the plurality of components based on the determined potential dependencies.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system including dynamic mapping of dependencies among components.

FIG. 2 shows an example dependency map generated by the server device of the system of FIG. 1.

FIG. 3 shows example logical components of the incident dependency detection engine of FIG. 1.

FIG. 4 shows example data sets analyzed by the correlator of FIG. 3.

FIG. 5 shows example logical components of the configuration management database agent engine of FIG. 1.

FIG. 6 shows example logical components of the code scanning engine of FIG. 1.

FIG. 7 shows example physical components of the server device of FIG. 1.

FIG. 8 shows an example method for determining dependencies as performed by the system of FIG. 1.

FIG. 9 shows an example method for updating application performance management with configuration information as performed by the system of FIG. 1.

FIG. 10 shows an example method for updating a configuration management database based on information from application performance management as performed by the system of FIG. 1.

FIG. 11 shows an example method for simulating components using application performance management as performed by the system of FIG. 1.

FIG. 12 shows an example method for determining dependencies as performed by the system of FIG. 1.

### DETAILED DESCRIPTION

This disclosure relates to dynamically generating a map of dependencies among components in a system.

Generally, current dependency mapping is static and is updated manually. In large networks, with many components being added or removed regularly, such dependency mapping can quickly fall out of date, and become unhelpful when attempting to resolve outages from production incidents, during planned maintenance of certain components, or the like.

Dynamic updating of the dependency map can improve the completeness and accuracy of the dependency map. The improved completeness and accuracy of the dependency map can improve responses to various outages such as production incidents, maintenance of certain components, or any other issues impacting the performance of the components. Complete, current, and accurate dependency information allows faster isolation of faulty components, reducing the duration and severity of incidents related to faults in such components. Accordingly, times to resolve issues can be reduced. Additionally, the improved completeness and accuracy of the dependency map can also improve planning and support. The improved completeness and accuracy of the dependency map can also save time for customers and support. Other advantages are possible.

By reviewing incidents periodically and identifying potential dependencies based on the timing of incident occurrence, incident-based dependency determination can support dynamic updating of dependencies, thereby improving dependency mapping for systems by making the dependency information more current and more complete. Incident based dependency determinations can allow dependency relationships to be identified even where not foreseen by engineers or other personnel, or that may not be detectable by other logging or modeling approaches. Incident-based dependency determination can further allow evolving dependencies in systems to be identified and understood over time. Other advantages are possible.

By using a configuration database management agent (CMDB agent) to interface with Application Performance Management (APM) tools used with the system, the dependency mapping information can be improved by providing the APM awareness of dependencies among components, even when such dependencies involve components that are not directly included in or interacting with the APM. For example, flow mapping in the APM can be used to enhance dependency data through the CMDB agent. Where components have confidential characteristics, a CMDB agent or a microservice between the CMDB agent and a third-party APM can provide the APM with masked or filtered data to remove, obscure, or otherwise protect confidential information. Additionally, by providing the dependency data to the APM through the CMDB agent, functionalities of the APM such as root cause analysis can be leveraged to determine the causes of faults and respond thereto, thereby improving the function of the system. Functionalities of the APM can also allow simulation of dependencies and changes thereto in a non-production environment, improving the testing of changes before their release. Other advantages are possible.

Scanning log files, code such as code in infrastructure repositories, and the like can further support the discovery of components and the relationships thereof to provide dynamic updating of dependencies. This can further enhance the completeness, currentness, and accuracy of the dependency data. Other advantages are possible.

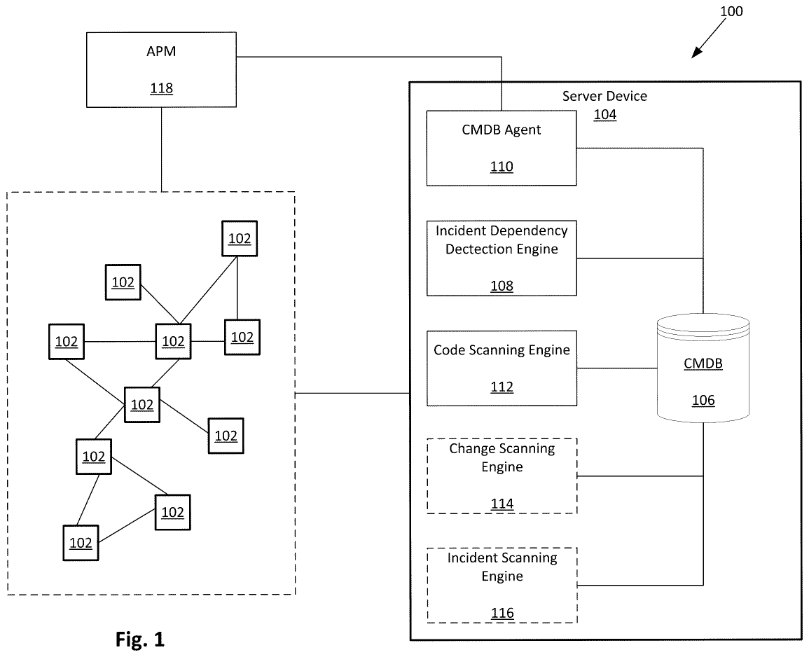

FIG. 1 shows an example system 100 including dynamic mapping of dependencies among components. System 100 includes a plurality of components 102, and a server device 104. Server device 104 includes a configuration management database (CMDB) 106, an incident dependency detection engine 108, a configuration management database agent (CMDB agent) 110, and a code scanning engine 112. Server device 104 can further include change scanning engine 114 and/or incident scanning engine 116. System 100 can optionally interface with application performance management (APM) 118. Each of components 102, server device 104, and APM 118 may be implemented as one or more computing devices with at least one processor and at least one memory. Example computing devices include a mobile computer, a desktop computer, a server computer, or other computing device or devices such as a server farm or cloud computing used to generate or receive data. Components 102, server device 104, and/or APM 118 can be connected with one another by one or more suitable network connections such as, for example, local area network(s), a wide area network(s), the internet, or a mixture thereof. Many different communication protocols can be used.

System 100 can be a networked system composed of a plurality of the components 102. In a non-limiting embodiment, system 100 is at least a portion of information technology infrastructure of a bank. Components 102 can be hardware, software, combinations thereof, or the like included in the system 100. The components 102 can include applications, services, microservices, networks or components thereof, infrastructure, databases, devices, or the like. Each of components 102 can be defined as a configurable item (CI) having associated information, including dependency information such as identification of other components 102 upstream or downstream of the component 102 defined in the CI. Components 102 can have dependencies on one another for proper function. The dependencies among components 102 can be hardware dependencies, software dependencies, combinations thereof, and the like.

Server device 104 is configured to dynamically determine and/or update dependencies of the components 102 in the CMDB 106. Server device 104 can receive incident information from the system 100 or individual components 102 thereof for processing by the incident dependency detection engine 108. Server device 104 can optionally access logs, code repositories, or the like for at least some components 102 of the system 100 for processing by the code scanning engine 112. Server device 104 can communicate with APM 118, for example through the CMDB agent 110 provided in server device 104.

CMDB 106 is a database configured to store information regarding components 102 and the dependencies and relationships thereof. The CMDB 106 can be the authoritative source of dependency information for system 100. The CMDB 106 is configured to receive component information from one or more of incident dependency detection engine 108, code scanning engine 112, change scanning engine 114 and/or incident scanning engine 116. The CMDB 106 can further be configured to receive component information from other suitable sources, such as dependency maps generated by engineers or other such personnel, information generated during development, configuration, or deployment of components 102, APM 118, or the like. The CMDB 106 can be stored in one or more memories. The component information can be stored in CMDB 106 as CIs for each of the components 102. The CIs stored in CMDB 106 can include the dependency data as upstream and/or downstream dependencies of the respective component 102.

Incident dependency detection engine 108 is configured to analyze incident data to determine potential dependency relationships based on incident data over time. The determination of potential dependency relationships can be determined, for example, by identifying incidents within similar time frames (for example using a k-nearest neighbor algorithm) and correlating such incidents. Incident dependency detection engine 108 can provide a notification regarding the potential dependency relationships, for example to allow an owner of a CI to accept or reject the potential dependency. Based on the determined potential dependencies and optionally the acceptance or rejection by the user, the incident dependency detection engine 108 can update the CMDB 106. In an embodiment, incident dependency detection engine 108 can be a job programmed in Python. In an embodiment, the incident dependency detection engine 108 can operate continuously or be operated at a certain frequency such as being operated daily.

CMDB agent 110 is configured to facilitate communication between the CMDB 106 and APM 118. CMDB agent 110 can be configured to receive requests for component information from APM 118, for example through a microservice such as a custom microservice, an application programming interface (API) or any other suitable interface with the APM 118. CMDB agent 110 can be provided, for example, as a microservice. The CMDB agent 110 can be configured to access the CMDB 106 to obtain requested component information, including upstream or downstream dependencies of the component. In an embodiment, the request from the APM 118 can be a request for a CI or the dependency information thereof. In an embodiment, the request from the APM 118 can be pursuant to determining a flow map at the APM 118. In an embodiment, CMDB agent 110 can be configured to filter, mask, or otherwise obscure or remove confidential information from component information being provided to the APM 118. Non-limiting examples of confidential information include component names, IP addresses, some sensitive dependency information (e.g., potential critical vulnerabilities) and the like. In an embodiment, the filtering, masking, or other removal of confidential data can be performed by a custom microservice included in the server device 104, for example in CMDB agent 110. In an embodiment, CMDB agent 110 can communicate simulated or pre-production dependency information to APM 118, and APM 118 can be used to validate dependency predictions, perform simulated traffic tests, or the like. CMDB agent 110 can provide the component information to APM 118 in response to individual requests, as a batch job, etc. In an embodiment, CMDB agent 110 can receive dependency information from the APM 118 and update the CMDB 106 with the received dependency information. For example, CMDB agent 110 can receive a CI from the APM 118 at a custom microservice, and the received CI can be added to or used to update the contents of CMDB 106.

Code scanning engine 112 is configured to scan code, for example repositories of code data and log files and/or inventory of infrastructure in the system 100 so as to identify components 102 that are new or have been modified relative to the component information stored in CMDB 106. Log files can be, for example log files provided in Splunk or the like. Code scanning engine 112 can be configured to update the CMDB 106 with new and/or modified components 102 detected by the code scanning engine 112. In an embodiment, code scanning engine 112 can create new CIs in CMDB 106 for new components 102 identified by the code scanning engine 112. In an embodiment, code scanning engine 112 can be provided as a job written in Python. In an embodiment, the code scanning engine 112 can operate continuously or be operated at a certain frequency such as being operated daily.

Change scanning engine 114 can be provided in server device 104. The change scanning engine 114 can scan change workflow objects that are implemented on system 100 Change scanning engine 114 can identify new components 102 as they are configured based on the change workflow objects. In an embodiment, change scanning engine 114 can create a CI in CMDB 106 for each identified new component 102.

Incident scanning engine 116 can be provided in server device 104. Incident scanning engine 116 can be configured to scan incident workflow objects in an information technology service management tool (ITSM). A non-limiting example of an ITSM is Service Now. The incident workflow objects can be closed incidents in the ITSM. The scanning of the incident workflow objects can include filtering of the incident workflow objects for fields indicative of relationships among components 102, such as incidents being caused by a component 102, a component 102 being impacted by an incident on another component 102, or the like. The incident scanning engine can verify the fields indicative of the relationships among the components 102. In an embodiment, incident scanning engine 116 can update the CMDB 106 based on the relationships among components included in the incident workflow objects.

APM 118 is configured to monitor and/or control at least some of the components 102 and performance thereof. In an embodiment, APM 118 can be a commercially available APM such as Elastic, App Dynamics, or the like. In an embodiment, APM 118 can be a third-party service. APM 118 can interface with at least some of the components 102 and with CMDB agent 110 of server device 104.

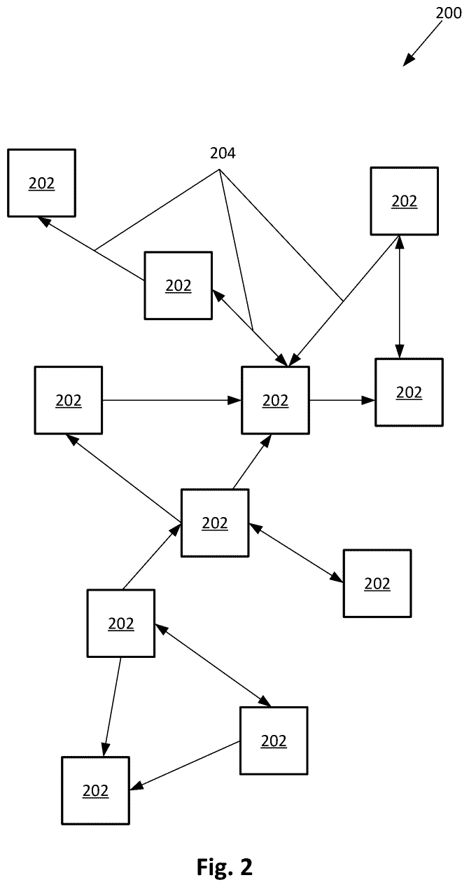

FIG. 2 shows an example dependency map 200 as generated by the server device 104 of FIG. 1. Dependency map 200 includes a plurality of nodes 202 joined by respective connections 204. The nodes 202 are representative of components of a networked system. The components can include physical components, software, data, combinations thereof, and the like. Non-limiting examples of components represented by nodes 202 can include applications, services, microservices, network components, infrastructure devices, server devices, databases, components thereof, or the like. The connections 204 show relationships among the nodes. The connections 204 can show dependencies, for example to indicate that a node is dependent on other nodes and may suffer impacts to performance when those other nodes experience issues.

The connections 204 can include a directionality of the dependence, for example identifying the upstream node 202 which can impact the function of one or more downstream nodes 202. In some networks, dependencies can be bi-directional, parts of feedback loops, or have other complex relationships among the dependencies of the nodes 202 and the impacts of issues occurring within certain nodes on other nodes 202. Dependency map 200 allows the relationships among the nodes 202 to be visualized and understood. The dependency map 200 can be dynamically updated by the system of FIG. 1 to improve the completeness and accuracy thereof regarding inclusion of suitable nodes 202 and the relationships thereof 204.

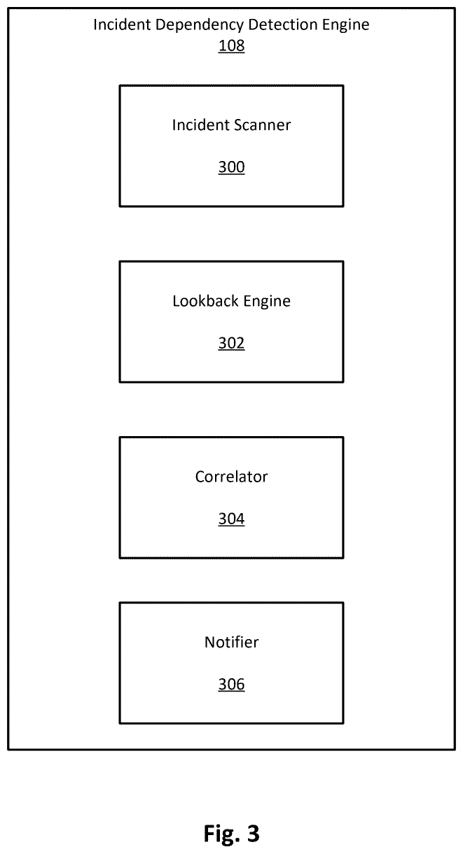

FIG. 3 shows example logical components of the incident dependency detection engine 108 of FIG. 1. Incident dependency detection engine 108 includes incident scanner 300, lookback engine 302, correlator 304, and notifier 306.

Incident scanner 300 is configured to scan incident data for system 100 and identify incidents to be processed. The incidents can be identified by incident scanner 300 in a predetermined period of time, for example a 24-hour period. The incidents can be any incidents occurring in components 102 of the system 100. The CIs for the components 102 identified as having incidents by the incident scanner 300 can be obtained.

Lookback engine 302 is configured to receive the incident data from incident scanner 300 and scan the CMDB 106 to determine components 102 having incidents within a same time frame as one another. The time frame can be a time frame selected to be indicative of the relatedness of the incidents, for example based on network latency, times of device operation, times of device interactions, and the like. The lookback engine 302 can determine the components 102 having incidents within the same time frame based on, as a non-limiting example, k-nearest neighbor algorithm. Other algorithms can be used, alone or in combination with one another. Components 102 identified by the lookback engine 302 as having incidents within the same time frame can be provided to correlator 304.

Correlator 304 receives instances of components having incidents within the same time frame from lookback engine 302. Correlator 304 can determine potential dependency relationships based on the received instances. In an embodiment, the correlator 304 can keep count of particular components 102 experiencing incidents within the time frame, and the potential dependency relationships among components 102 can be determined based on the count. In an embodiment, correlator 304 can receive a plurality of data sets each including instances of components having incidents within the same time frame. The data sets can each be for a different time period, for example, the last 24 hours, the last week, and the last month. The correlator 304 can determine the potential dependency relationships based on the frequency of components 102 experiencing incidents within the same time frame across the plurality of data sets.

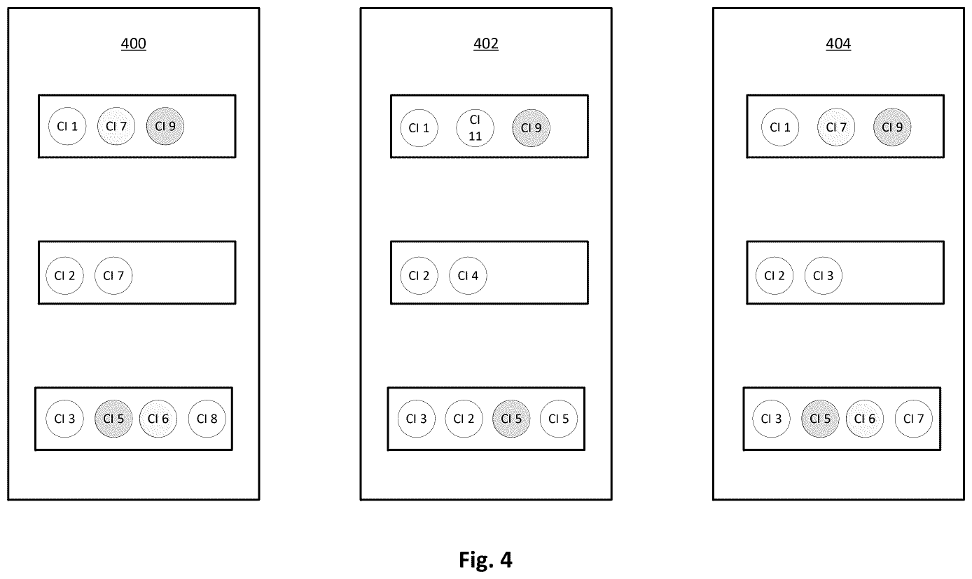

FIG. 4 shows example data sets being processed by the correlator 304 to determine potential dependency relationships. The example data sets include first data set 400 containing data for the past 24 hours, second data set 402 containing data for the past week, and third data set 404 containing data for the last month, each relative to the time the correlator 304 is determining the potential dependency relationships. The example data sets 400, 402, 404 each track components 102 by the respective CI. The example data sets track CI 1, CI 2, and CI 3 as the components 102 for which the potential dependency relationships are to be determined by the correlator 304.

For CI 1, the first data set 400 includes CI 7 and CI 9 as components 102 experiencing incidents within the time window along with CI 1. The second data set 402 includes CI 11 and CI 9 as components 102 experiencing incidents within the time window along with CI 1. The third data set includes CI 7 and CI 9 as components 102 experiencing incidents within the time window along with CI 1. Based on CI 9 experiencing incidents within the time window along with CI 1, correlator 304 can determine CI 1 and CI 9 as having a potential dependency relationship. In an embodiment, CI 7 can be identified as a potential dependency relationship by correlator 304, based on recurrence in the first and third data sets 400, 404 even when absent from the second data set 402. Alternately, CI 7 can be identified for further monitoring, testing in additional data sets, or the like.

For CI 2, the first data set 400 includes CI 5 as having an incident within the time window along with CI 2. The second data set 402 includes CI 4 as having an incident within the time window along with CI 2. The third data set 404 includes CI 3 as having an incident within the time window along with CI 2. Since no component shows recurring incidents within the time window along with CI 2, the correlator 304 can determine that there are no potential dependency relationships for CI 2 present in first, second, and third data sets 400, 402, 404.

For CI 3, first data set 400 includes CI 5, CI 6, and CI 8 as components 102 experiencing incidents within the time window along with CI 1. The second data set 402 includes CI 2, CI 5, and CI 9 as components 102 experiencing incidents within the time window along with CI 1. The third data set includes CI 7 and CI 9 as components 102 experiencing incidents within the time window along with CI 1. Based on CI 9 experiencing incidents within the time window along with CI 1, correlator 304 can determine CI 1 and CI 9 as having a potential dependency relationship. In an embodiment, CI 7 can be identified as a potential dependency relationship by correlator 304, based on recurrence in the first and third data sets 400, 404 even when absent from the second data set 402. Alternately, CI 7 can be identified for further monitoring, testing in additional data sets, or the like.

Returning to FIG. 3, notifier 306 is configured to generate a notification regarding a potential dependency identified by the correlator 304. The notification can be provided to an owner of one or more of the components 102 having the potential dependency relationship. The owner of the components 102 can be an organization, a named individual, an automated service, or any other suitable person or object responsible for the function of said components 102. The notification can be provided in any suitable form, such as an alert, a ticket, a message, an e-mail, or the like. The notification provided by notifier 306 can prompt the owner of the of one or more of the components 102 having the potential dependency relationship to accept or reject the potential dependency relationship. In an embodiment, following receipt of an acceptance of the potential dependency relationship, the incident dependency detection engine 108 can cause the CMDB 106 to be updated with the accepted potential dependency relationship.

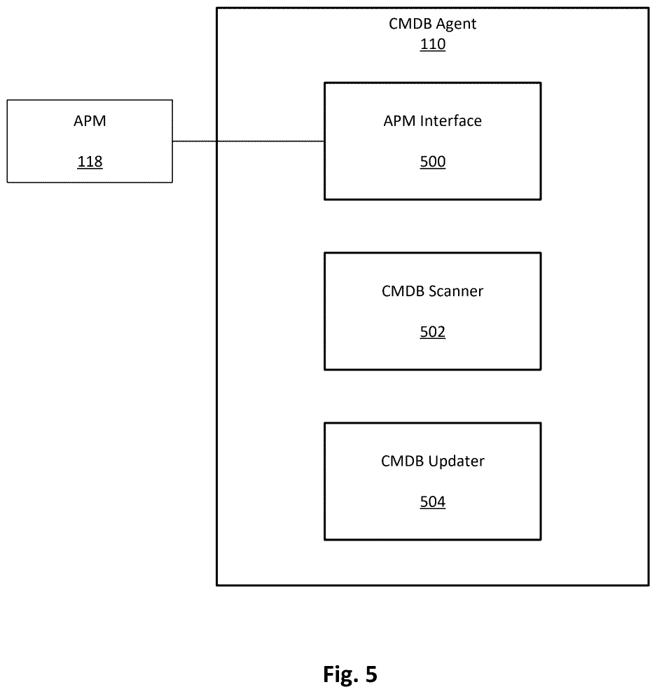

FIG. 5 shows example logical components of the CMDB agent 110 of FIG. 1. CMDB agent 110 includes APM interface 500, CMDB scanner 502, and CMDB updater 504.

APM interface 500 can be a microservice configured to interface with an APM 118, for example a custom microservice. The APM interface 500 can be configured for a specific APM 118 being used with system 100. APM interface 500 can receive communications from the APM 118, for example receiving a request for updated dependency information, receiving dependency information from the APM 118, or the like. The APM interface 500 can send communications to the APM 118, such as dependency information, a CI including dependency information, or the like. The APM interface 500 can be configured to filter confidential data to remove, obscure, or otherwise protect confidential information, such as component names, IP addresses, some sensitive dependency information (e.g., potential critical vulnerabilities) and the like from the communications to the APM 118. The communications to the APM 118 by the APM interface 500 can include forwarding components information from a non-production environment such that the APM 118 can be used to generate simulated dependency information.

CMDB scanner 502 can be configured to scan the CMDB 106 to obtain dependency information such as CIs. The CMDB scanner 502 can be operated on a periodic basis, for example daily, or in response to a request from the APM 118 received at the APM interface 500. The CMDB scanner 502 can be configured to identify new CIs in CMDB 106. In an embodiment, when a new CI is detected by the CMDB scanner 502, the CMDB scanner 502 can forward the CI to the APM interface 500. In an embodiment, the APM interface 500 can provide the CMDB scanner 502 with a request for a particular CI or the dependency information thereof, and the CMDB scanner 502 can retrieve the requested information from the CMDB 106. The CMDB scanner 502 can provide the retrieved information to the APM interface 500 to be provided to APM 118.

CMDB updater 504 can be configured to modify the contents of CMDB 106, for example adding new entries, updating existing entries, or the like. The CMDB updater 504 can modify the contents of the CMDB 106 based on information received at APM interface 500, such as simulated or real dependencies determined at the APM 118, newly identified CIs verified or determined at the APM 118, and the like.

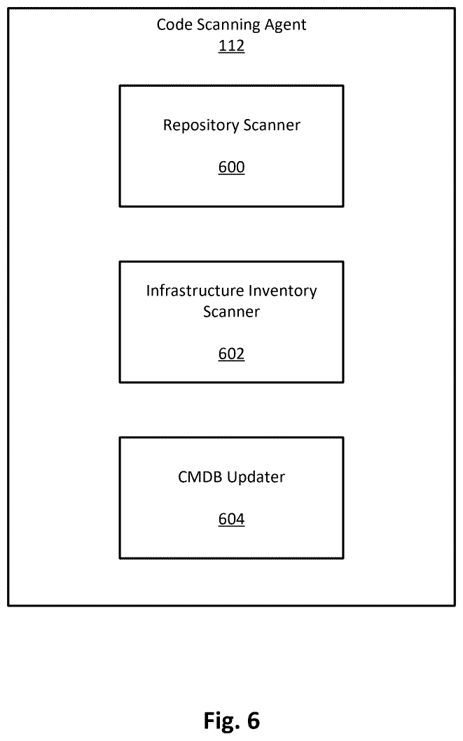

FIG. 6 shows example logical components of the code scanning engine 112 of FIG. 1. Code scanning engine 112 includes repository scanner 600, infrastructure inventory scanner 602, and CMDB updater 604.

Repository scanner 600 is configured to periodically access one or more repositories of code data and log files, and based on the code data and log files, identify any new or modified components 102 in the system 100. Repository scanner 600 can be configured to access the one or more repositories according to any suitable periodic schedule, for example a weekly schedule.

Infrastructure inventory scanner 602 is configured to periodically access the inventory of infrastructure of the system 100 to identify any new or modified components from said inventory. The infrastructure inventory scanner 602 can be configured to access the one or more repositories according to any suitable periodic schedule, for example a weekly schedule.

CMDB updater 604 is configured to modify the CMDB 106 to create new CIs for new components 102 as identified by repository scanner 600 and/or infrastructure inventory scanner 602 and to update existing CIs for modified components 102 as identified by repository scanner 600 and/or infrastructure inventory scanner 602. CMDB updater 604 can generate new CIs in CMDB 106 for each of the components 102 identified as new by the repository scanner 600 and the infrastructure inventory scanner 602. The CMDB updater 604 can edit CIs in CMDB 106 for components 102 to reflect the modifications to the components 102 identified as new by the repository scanner 600 and the infrastructure inventory scanner 602.

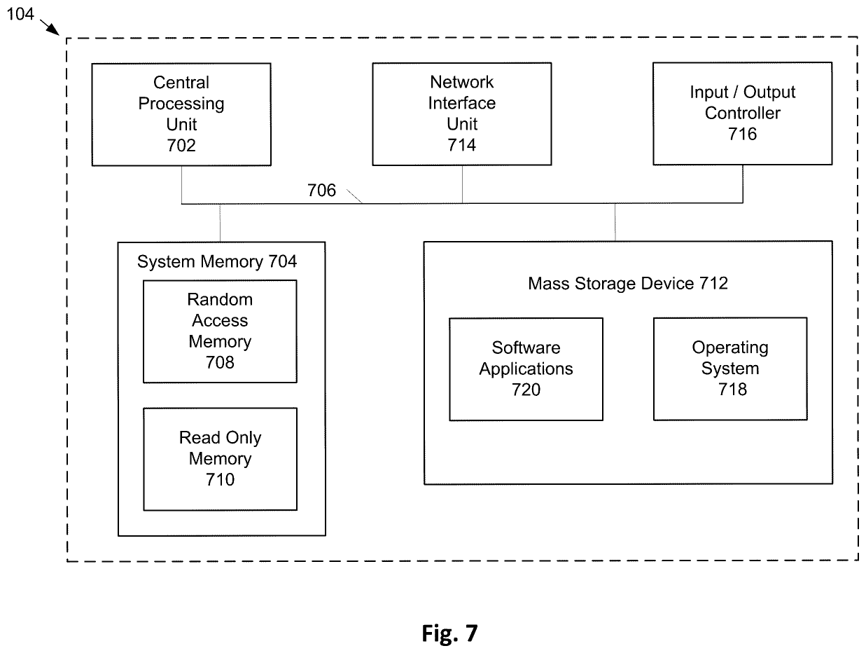

FIG. 7 shows example physical components of the server device of FIG. 1. Server device 104 includes can include at least one central processing unit (“CPU”) 702, a system memory 704, and a system bus 706 that couples the system memory 704 to the CPU 702. The system memory 704 includes a random-access memory (“RAM”) 708 and a read-only memory (“ROM”) 710. A basic input/output system containing the basic routines that help transfer information between elements within the server device 104, such as during startup, is stored in the ROM 710. The server device 104 further includes a mass storage device 712. The mass storage device 712 can store software instructions and data. A central processing unit, system memory, and mass storage device similar to that shown can also be included in the other computing devices disclosed herein.

The mass storage device 712 is connected to the CPU 702 through a mass storage controller (not shown) connected to the system bus 706. The mass storage device 712 and its associated computer-readable data storage media provide non-volatile, non-transitory storage for the server device 104. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions. Computer-readable data storage media include volatile and non-volatile, removable and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 104.

According to various embodiments of the invention, the server device 104 may operate in a networked environment using logical connections to components 102 and/or APM 118, such as a wireless network, the internet, or another type of network. The server device 104 may connect to components 102 and/or APM 118 through a network interface unit 714 connected to the system bus 706. It should be appreciated that the network interface unit 714 may also be utilized to connect to other types of networks and remote computing systems. The server device 104 also includes an input/output controller 716 for receiving and processing input from a number of other devices, for example a touch user interface display screen or another type of input device. Similarly, the input/output controller 716 may provide output to a touch user interface display screen or other output devices.

As mentioned above, the mass storage device 712 and the RAM 708 of the server device 104 can store software instructions and data. The software instructions include an operating system 718 suitable for controlling the operation of the server device 104. The mass storage device 712 and/or the RAM 708 also store software instructions and applications 720, that when executed by the CPU 702, cause the server device 104 to provide the functionality of the server device 104 discussed in this document.

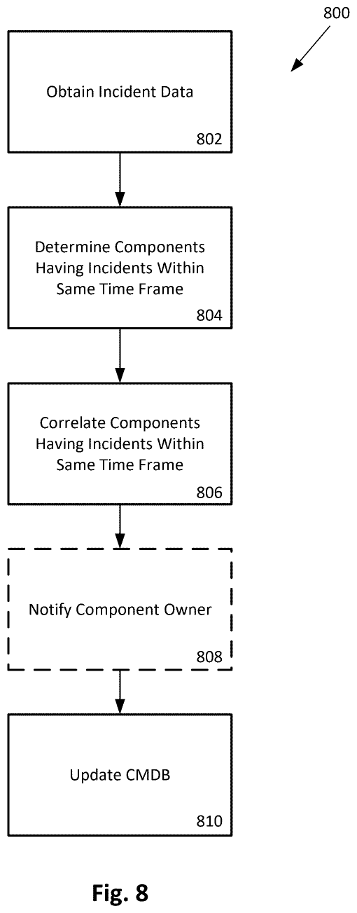

FIG. 8 shows an example method for determining dependencies as performed by the system of FIG. 1. Method 800 includes obtaining incident data for a plurality of components at 802, determining components 102 having incidents within a same time frame as one another at 804, and correlating components 102 having incidents within the same time frame to determine potential dependencies at 806. Method 800 can further include notifying a component owner regarding potential dependencies at 808 and updating CMDB 106 at 810.

Incident data for a plurality of components 102 is obtained at 802. The incident data can be individual incident data for each of the plurality of components 102. The incident data can be for a predetermined period of time, such as a 24-hour period. The incident data can include timestamps indicative of the timing of the incident, for example the time at which the incident began, a time of resolution or ending of the incident, a duration of the incident, and the like. The incident data can be obtained at 802 from any suitable source, such as polling the plurality of components 102, receiving the incident data from an ITSM, or the like.

Components 102 having incidents occurring within a same time frame are identified at 804 by processing the incident data obtained at 802. The time frame can be a time frame selected to be indicative of the relatedness of the incidents, for example based on network latency, times of device operation, times of device interactions, and the like. The processing of the incident data at 804 can be according to any suitable method, for example a k-nearest neighbor algorithm. Other algorithms can be used, alone or in combination with one another. The identification of components having incidents occurring within a same time frame at 804 can be stored, for example for later use such as the correlating of components 102 having incidents within the same time frame to determine potential dependencies at 806.

Potential dependency relationships are determined by correlating components 102 having incidents within the same time frame at 806. In an embodiment, correlating components 102 having incidents within the same time frame includes keeping count of particular components 102 experiencing incidents within the time frame. The potential dependency relationships among components 102 can be determined based on the count. Data sets used for the correlating of components 102 having incidents within the same time frame at 806 can include data sets for each of a plurality of different time periods, for example, the last 24 hours, the last week, and the last month. The potential dependency relationships can be determined based on the frequency of components 102 experiencing incidents within the same time frame across the data sets, for example as discussed above with respect to FIG. 4.

A component owner can be notified of the potential dependency at 808, for example by providing a notification, such as an alert, a ticket, a message, an e-mail, or the like to the component owner. The component owner can be an organization, a named individual, an automated service, or any other suitable person or object responsible for the function of components 102 identified as having the potential dependency relationship. In an embodiment, the notification can include a prompt for an acceptance or rejection of the potential dependency relationship.

The CMDB can be updated with the dependency at 810, for example by updating the dependency data included in a CI for a particular component 102. In an embodiment, the CMDB can be updated with dependency relationships that have been approved by component owners following the notification at 808. In an embodiment, the CMDB can be updated with the potential dependency relationships determined by the correlation at 806.

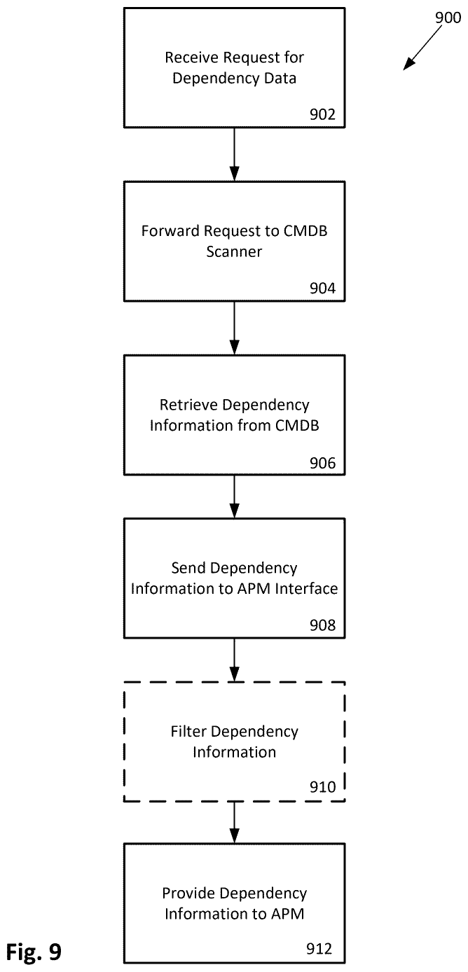

FIG. 9 shows an example method for updating APM 118 with configuration information as performed by the system of FIG. 1. Method 900 includes receiving a request for dependency information for one or more of the components 102 from the APM 118 at APM interface 500 at 902, forwarding the request from the APM interface 500 to a CMDB scanner 502 at 904, retrieving the dependency information from CMDB 106 at 906, and sending the dependency information from the CMDB scanner at 502 to the APM interface 500 at 908. Optionally, the APM interface 500 can filter confidential information from the dependency information at 910. The dependency information can be provided from the APM interface 500 to the APM 118 at 912.

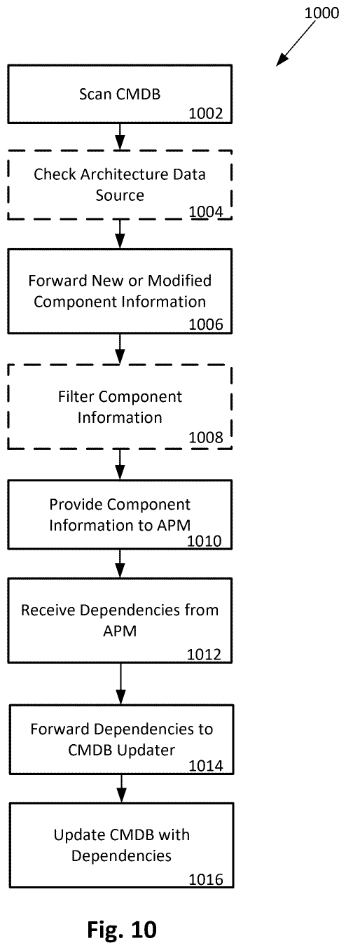

FIG. 10 shows an example method for updating CMDB 106 based on information from APM 118 performed by the system of FIG. 1. Method 1000 can include CMDB scanner 502 scanning the CMDB 106 to obtain new or modified component information at 1002. The method 1000 can optionally include checking an architecture data source for dependency information for the components 102 included in the new or modified component information at 1004. Method 1000 further includes forwarding the new or modified component information to APM interface 500 at 1006. Optionally, the APM interface 500 can filter confidential information from the new or modified component information at 1008. The APM interface 500 can provide the new or modified component information to the APM 118 at 1010. The APM 118 can process the new or modified component information to determine dependencies for new or modified components, for example according to dependency mapping functions included therein, and dependencies determined at the APM 118 can be received at APM interface 500 at 1012. The determined dependencies can be forwarded from APM interface 500 to CMDB updater 504 at 1014, and the CMDB updated based on the determined dependencies at 1016. Accordingly, the APM 118 can be utilized to determine dependencies for components, even if those components are not directly exposed to the APM 118.

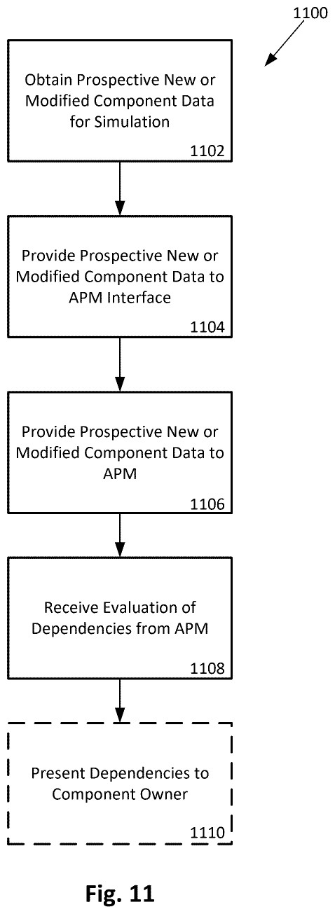

FIG. 11 shows an example method for simulating components using an APM 118 performed by the system of FIG. 1. Method 1100 includes obtaining prospective new or modified component information to be used for simulation at 1102. The prospective new or modified component information can be obtained at 1102 from, for example, an architecture data source. The prospective new or modified component information is obtained at 1102 from a non-production environment. The prospective new or modified component information obtained at 1102 can be provided to the APM interface 500 at 1104. The prospective new or modified component information is provided from APM interface 500 to APM 118 at 1106. At APM 118, the prospective new or modified component information can be evaluated, for example having dependencies identified using functions of the APM 118. In an embodiment, the evaluation at APM 118 can include simulation of traffic to identify dependencies of the prospective new or modified components. The traffic can be simulated, for example, by a synthetic transaction tool included in the APM 118. The evaluation of dependencies can be received from APM 118 at the APM interface 500 at 1108. The evaluation of dependencies received at 1108 can be optionally presented to a component owner at 1110, for example to accept or reject the potential dependencies identified in the evaluation, to guide further development of the prospective new or modified components, or the like.

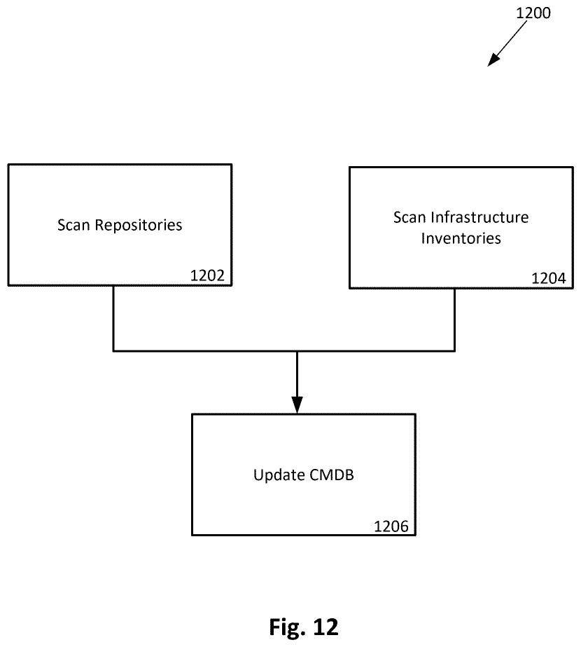

FIG. 12 shows an example method for scanning components for dependencies as performed by the system of FIG. 1. Method 1200 includes scanning one or more repositories at 1202 and/or scanning one or more infrastructure inventories at 1204, and updating a CMDB at 1206.

Scanning one or more repositories at 1202 can include scanning one or more repositories of code data and log files and identifying any new or modified components 102 in the system 100 based on the code data and log files. The repositories can include code repositories, such as a Git repository, log file repositories such as a repository of Splunk log files, combinations thereof, or the like. The scanning of the one or more repositories at 1202 can be performed according to any suitable periodic schedule, for example a weekly schedule.

An inventory of infrastructure of the system 100 can be scanned at 1204. The scanning of the infrastructure inventory can identify any new or modified components 102 from said inventory. The scanning of the infrastructure inventory at 1204 can be performed according to any suitable periodic schedule, for example a weekly schedule.

The CMDB 106 can be updated at 1204 based on the new or modified components identified in the scanning of the one or more repositories at 1202 and/or the scanning of the infrastructure inventory at 1204. The updating of CMDB 106 at 1206 can include creating new CIs for new components 102 and/or editing CIs in CMDB 106 for components 102 to reflect the modifications to the components 102 identified in the scanning of the one or more repositories at 1202 and/or the scanning of the infrastructure inventory at 1204.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer system for mapping component dependencies, comprising:
one or more processors; and
non-transitory computer-readable storage media encoding instructions which, when executed by the one or more processors, cause the computer system to:
obtain incident data for a plurality of components, the incident data including times of incident occurrence at components of the plurality of components;
determine potential dependencies among said components of the components of the plurality of components, based on the times of incident occurrence at said components of the plurality of components;
update a database including dependency information for the plurality of components based on the potential dependencies;
apply an algorithm to the incident data to identify components experiencing incidents within a same time frame;
correlate occurrences of the components experiencing incidents within the same time frame across a plurality of data sets for different time periods to determine the potential dependencies; and
generate dependency mappings that improve completeness and accuracy of the dependency information for the plurality of components.

2. (canceled)

3. The computer system of claim 1, wherein the instructions further cause the computer system to use a k-nearest neighbor algorithm to the incident data to scan the incident data.

4. (canceled)

5. The computer system of claim 1, wherein the instructions further cause the computer system to notify a component owner regarding the potential dependencies for a component owned by the component owner, and receive, from the component owner, an acceptance or rejection of the potential dependencies of the component owned by the component owner.

6. The computer system of claim 5, wherein the instructions cause the computer system to update the database including the dependency information based on the potential dependencies accepted by the component owner.

7. The computer system of claim 1, wherein the instructions further cause the computer system to, in response to a request from application performance management (APM) for at least some of the dependency information and obtain said at least some of the dependency information from the database at an agent configured to interface with the APM.

8. The computer system of claim 7, wherein the instructions cause the computer system to filter or mask confidential information included in said at least some of the dependency information to produce filtered dependency information and provide said filtered dependency information to the APM.

9. The computer system of claim 1, wherein the instructions cause the computer system to scan one or more of a code repository, log files, or an infrastructure inventory to identify new or modified components of the plurality of components, and update the database based on the identified new or modified components of the plurality of components.

10. The computer system of claim 9, wherein the instructions cause the computer system to generate a configuration item for each identified new component of the identified new or modified components of the plurality of components to update the database.

11. A method for mapping component dependencies, comprising:
obtaining incident data for a plurality of components, the incident data including times of incident occurrence at components of the plurality of components;
determining potential dependencies among said components of the plurality of components, based on the times of incident occurrence at said components of the plurality of components;
updating a database including dependency information for the plurality of components based on the potential dependencies;
applying an algorithm to the incident data to identify components experiencing incidents within a same time frame;
correlating occurrences of the components experiencing incidents within the same time frame across a plurality of data sets for different time periods to determine the potential dependencies; and
generating dependency mappings that improve completeness and accuracy of the dependency information for the plurality of components.

12. (canceled)

13. The method of claim 11, wherein scanning the incident data includes using a k-nearest neighbor algorithm.

14. (canceled)

15. The method of claim 11, further comprising notifying a component owner regarding the potential dependencies for a component owned by the component owner, and receive, from the component owner, an acceptance or rejection of the potential dependencies of the component owned by the component owner.

16. The method of claim 15, wherein updating the database including the dependency information is based on the potential dependencies accepted by the component owner.

17. The method of claim 11, further comprising, in response to a request from application performance management (APM) for at least some of the dependency information, obtaining said at least some of the dependency information from the database at an agent configured to interface with the APM.

18. The method of claim 17, further comprising filtering or masking confidential information included in said at least some of the dependency information to produce filtered dependency information and providing said filtered dependency information to the APM.

19. The method of claim 11, further comprising scanning one or more of a code repository, log files, or an infrastructure inventory to identify new or modified components of the plurality of components, and updating the database based on the identified new or modified components of the plurality of components.

20. The method of claim 19, further comprising generating a configuration item for each identified new component of the identified new or modified components of the plurality of components to update the database.
